(19) United States
(12) Patent Application Publication
(10) Pub. No.: US 2017/0290406 A1
(43) Pub. Date: Oct. 12, 2017

(54) COLOR-DISPENSING SYSTEM

(71) Applicants: Dmitriy Shimanov, Huntington, NY (US); Igor Baruch, Huntington, NY (US)

(72) Inventors: Dmitriy Shimanov, Huntington, NY (US); Igor Baruch, Huntington, NY (US)

(21) Appl. No.: 15/094,060

(22) Filed: Apr. 8, 2016

(51) Int. Cl. A45D 44/00; B67D 7/14

(52) U.S. Cl. CPC A45D 44/005; B67D 7/14; B67D 2210/00049; A45D 2044/007

(57) ABSTRACT

An automated hair color dispensing device that includes: a plurality of color cartridges; tubing extending from each cartridge; an input color selection; a control system, wherein the control system releases color from a subset of the plurality of color cartridges based upon the input color selection; and a means to provide the input color selection. The means to provide the input color selection may be a scanner or a software application, where the software application is available on a computer tablet.

### BACKGROUND OF THE INVENTION

### Field of Invention

The present invention relates to a hair color mixing and dispensing device.

### Description of Related Art

Many individuals wear various types of hair colors depending on preference and style. Some of the reasons for hair coloring relates to coloring gray hairs or adding additional fashionable color. Further, tinting is another particular aspect of hair coloring where individuals tint certain portions of the hair to create a desired look. Hair stylists typically mix various colors to achieve a particular shade as desired. However the manual mixing of hair coloring produces wasted materials and increased costs related to the coloring process. Further in order to get the desired color there may be a trial and error in the mixing of colors and therefore producing waste while trying to accomplish the desired look.

### SUMMARY OF THE INVENTION

The present invention relates to an automated hair color dispensing device that includes: a plurality of color cartridges; tubing extending from each cartridge; an input color selection; a control system, wherein the control system releases color from a subset of the plurality of color cartridges based upon the input color selection; and a means to provide the input color selection. The means to provide the input color selection may be a scanner or a software application, where the software application is available on a computer tablet.

### BRIEF DESCRIPTION OF DRAWINGS

FIG. 1 depicts an interior view of a hair color mixing and dispensing device.

FIG. 2 depicts a cover for the hair color mixing and dispensing device.

### DETAILED DESCRIPTION

The present invention relates to a device that provides an automated means for mixing and dispensing hair color. The present invention includes a plurality of cartridges or tubes arranged within the interior of the device. Tubes extend from these cartridges into a main mixing bowl. Each tube may be filled with a distinct color for mixing purposes. Once the desired mix is achieved the hair dye is available for use by hair stylists or user. A scanner is available that enables a user to scan color and therefore provide a suitable match for the desired hair color. Further electronic controls are available to create the desired mix manually by the hair stylist. A user may utilize an application installed on a tablet to sort and choose a desired color. The dispensing device includes Bluetooth or WiFi connectivity to accomplish a connection with the user's tablet. The application allows the user to create various colors associated with the colors available within the dispenser.

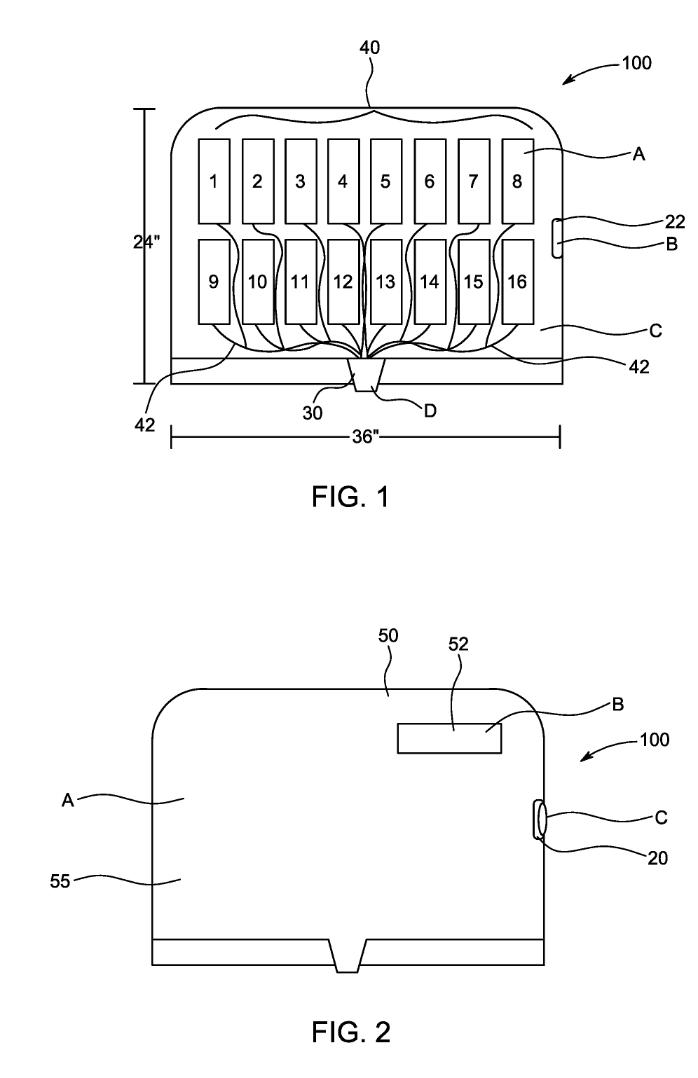

In reference to FIG. 1, an interior view of a color-dispensing device 100 is depicted. The interior of the color-dispensing device is preferably covered with a cover 50 as shown in FIG. 2. The interior of the color-dispensing device includes a plurality of cartridges 40 arranged in two rows as shown in FIG. 1. Although 16 cartridges are shown, this number may vary and may be increased or decreased as desired. Tubing 42 extends from each cartridge within the color-dispensing device 100. The tubing 42 leads to a bowl 30 that receives the coloring from each cartridge as indicated. The coloring can be matched to a hair of a user by the use of a scanner 22 shown on one side of the color-dispensing device 100. Once scanned the color is created through the use of available dyes in the cartridges 40. Alternatively, the color selection may be accomplished through use of an application available on a user tablet. The user simply selects from the colors available in the application and the color selection is executed through the mixing of available colors in the plurality of cartridges 40.

The cover 50 in FIG. 2 includes a surface area 55 that extends over the interior of the color-dispensing device 100. A screen 52 is also provided on the cover 50 the cartridges in the interior of the color-dispensing device 100. The screen 52 provides a communication means for the user when operating the color-dispensing device 100. A separate cover 20 is provided to cover the scanner 22 so that it is also protected when not in use. A user may scan the desired color with the scanner 22 and an appropriate matching color is created with the various color cartridges shown in FIG. 1. The instant invention has been shown and described in what it considers to be the most practical and preferred embodiments. It is recognized, however, that departures may be made there from within the scope of the invention and that obvious modifications will occur to a person skilled in the art.

What is claimed is:

1. An automated hair color dispensing device comprising:
a. a plurality of color cartridges;
b. tubing extending from each cartridge;
c. an input color selection;
d. a control system, wherein the control system releases color from a subset of the plurality of color cartridges based upon the input color selection; and
e. a means to provide the input color selection.

2. The automated hair color dispensing device according to claim 1, where the means to provide the input color selection is a scanner.

3. The automated hair color dispensing device according to claim 1, where the means to provide the input color selection is a software application.

4. The automated hair color dispensing device according to claim 3, where the software application is available on a computer tablet.

5. The automated hair color dispensing device according to claim 1, further including a bowl, where the bowl receives coloring from the tubing after execution of the input color selection.

6. The automated hair color dispensing device according to claim 1, where the plurality of cartridges are positioned within an interior cavity and a cover is a provided to cover the cartridges during use.

7. The automated hair color dispensing device according to claim 6, where the cover includes a screen.

8. The automated hair color dispensing device according to claim 2, further including a cover for the scanner.
